(19) United States
(12) Patent Application Publication
(10) Pub. No.: US 2008/0072012 A1
(43) Pub. Date: Mar. 20, 2008

(54) System and method for processing user defined extended operation

(75) Inventor: Hee Seok Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/645,771

(22) Filed: Dec. 27, 2006

(30) Foreign Application Priority Data
Sep. 18, 2006 (KR) 10-2006-0090060

(51) Int. Cl. G06F 15/00

(52) U.S. Cl. 712/34; 712/215

(57) ABSTRACT

An operation system and method of processing a user-defined extended operation are provided. The method includes using a software pipelining technology by enabling a processor to process a user-defined extended operation. An operation process system includes a plurality of functional units which are operable to process a primitive operation and a processor which is operable to process an extended operation according to a control of each of the functional units.

### CROSS-REFERENCE TO RELATED APPLICATION

This application claims priority from Korean Patent Application No. 10-2006-0090060, filed on Sep. 18, 2006, in the Korean Intellectual Property Office, the entire disclosure of which is incorporated herein by reference.

### BACKGROUND OF THE INVENTION

1. Field of the Invention

Apparatuses and methods consistent with the present invention relate to processing a user-defined extended operation, more particularly, to processing a primitive operation and a user-defined extended operation to enhance efficiency of an operation process via a software pipelining.

2. Description of Related Art

As devices including an operation device executing a program, such as a computer, a personal digital assistant (PDA), a cellular phone, and the like, have come into wide use, research on a method of quickly processing an operation for executing the program is underway. There is software pipelining technology as a result of the research.

FIG. 1 is a diagram illustrating a method of implementing a software pipelining technology.

A pseudopodia listing 110 illustrates a part of a software program that is required to processed in an operation process system. In FIGS. 1, A, B, C, and D indicate an operation that is a basic unit configuring each program and generally include the operations processed via an arithmetic logic unit (ALU), for example, addition, subtraction, multiplication, shift, logical sum, logical multiplication, and the like, and the operation provided for a memory access, for example, a load, a store, and the like. Also, an instruction code, i.e., JMP L of the last line indicates that it is required to return to a location L: located at the operation A of the uppermost line. Specifically, when a program in psuedocode listing 110 is executed, the operations of A, B, C, and D are implemented in order and the operations from A to D are continuously repeated.

Another psuedocode listing 120 illustrates an operation process in the case of executing the program in the psuedocode listing 110, eliminating a use of the software pipelining technology. The program in the psuedocode listing 110 is executed in an indefinite loop due to a lack of an exit condition, but the program in the psuedocode listing 110 is here limited to within a loop of repeating four times for convenience of comparison. Similar to the other psuedocode listing 120, unless the software pipelining is implemented, the operation of A, B, C, and D is implemented in order and the operation of A is implemented again. Similarly, when the operation of A, B, C and D repeats four times, a total of sixteen operations are implemented. In FIG. 1, each operation is referred to as a cycle and an operation time of total sixteen cycles is required in the psuedocode listing 120.

Still another psuedocode listing 130 illustrates an operation process in the case of executing the program in the psuedocode listing 110 by using the software pipelining technology. As illustrated in FIG. 1, the software pipelining technology is a technology where a first operation A of a first loop is implemented, and when a second operation B is implemented, a first operation A of the second loop is simultaneously implemented. When the above operations of A, B, C, and D are independent of each other, up to four operations are simultaneously implemented. The operation may be implemented more efficiently by enabling the operation to be simultaneously implemented. In the present example, the operations may be repeatedly implemented four times as illustrated in the psuedocode listing 120, and may be also completed within total seven cycles by simultaneously implementing a maximum of four operations. Similarly, when the software pipelining technology is used, the repetitive operations may be processed with great efficiency.

However, it is required to exclude a conditional flow from the loop to use the software pipelining technology. The conditional flow indicates the operation that lets another operation be implemented depending on a condition. Specifically, the conditional flow indicates the operation to be implemented depending on the condition, for example, in a case where as a result of comparing X with Y, the operation A is implemented when X is larger than Y, and the operation B is implemented when Y is larger than X.

When the above conditional flow is included in the loop, an operation may not be repeatedly implemented in a predetermined order as illustrated in the still another psuedocode listing 130 and accordingly, configuring a pipeline is extremely difficult. When the operation is repeatedly implemented in the case an operation order is set, as illustrated in the still another psuedocode listing 130, an operation group of D, C, B, and A such as the fourth line is repeatedly processed. Thus, when a configuration of the pipeline is simple but another operation is executed, an identical operation group is not repeatedly processed and accordingly, the pipeline may not be configured.

However, since programs generally include conditional flows, when the software pipelining technology is used for only loops excluding the conditional flow, an extent of use may be greatly reduced.

Accordingly, methods of enabling the software pipelining for loops including the conditional flow have been attempted. A method among the methods of enabling the software pipelining for loops including the conditional flow is a method similar to an operation where the conditional flow is excluded and a new operation is implemented by defining as the new operation another operation including the conditional flow and adding hardware for processing the new operation. However, since the method that the conditional flow is excluded and the new operation that is implemented is required to include hardware to process the complex operation, there is a problem that costs are high and a portion including the conditional flow may not be processed except by the new operations defined when the hardware is designed.

Thus, according to the present invention, there is provided an operation process system and method of using the software pipelining technology more generally and efficiently processing the operation by enabling a user to use the software pipelining technology with a loop including a conditional flow, and to define and add the new operation.

### SUMMARY OF THE INVENTION

The present invention provides a system and method of simply using a software pipelining technology.

The present invention also provides a system and method of processing an extended operation in software by enabling a separate processor to process the extended operation.

The present invention also provides a system and method of adding an extended operation desired by a user by processing the extended operation in software.

The present invention also provides a system and method of efficiently using a processor by generating an exception, enabling the processor to process an extended operation, and using an exception handler in the processor.

According to an aspect of the present invention, there is provided an operation process system of processing an operation of a computer program, the system including: a plurality of functional units processing a primitive operation; and a processor processing an extended operation according to a control of each of the plurality of functional units.

According to another aspect of the present invention, there is provided an operation process method of processing an operation of a computer program, the method including: receiving the operation from each of a plurality of functional units; processing the operation with each of the plurality of functional units when the operation is a primitive operation; and processing an extended operation by controlling a processor when the operation is the extended operation.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating a method of implementing a software pipelining technology;

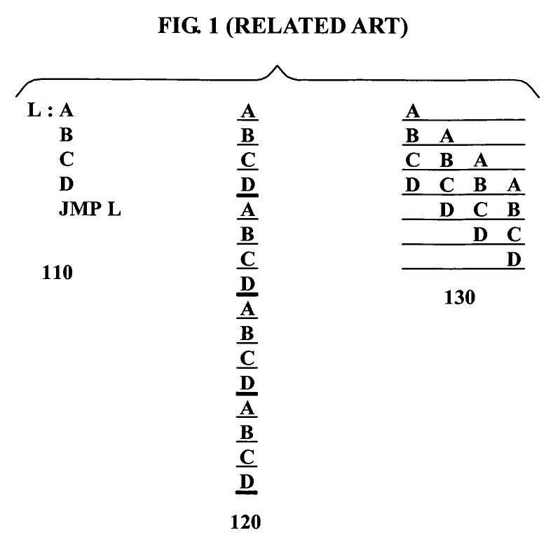

FIG. 2 is a configuration diagram illustrating a configuration of an operation process system according to an exemplary embodiment of the present invention;

FIG. 3 is a configuration diagram illustrating a system configuration for processing an extended operation in an operation process system according to an exemplary embodiment of the present invention; and

FIG. 4 is a flowchart illustrating a flow of an operation process method according to an exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

In the present invention, an operation indicates a basic unit comprising a program. The program is executed in a device, such as a computer and the like, is made of a plurality of operations and the operations are generally defined in the case of designing for a process, and modified to be processed in hardware. Thus, after the hardware is configured, further operations may not be added. Also, since the present invention has a characteristic that a user-defined extended operation may be added, the operation processed in the conventional hardware is referred to as a “primitive operation” and the user-defined operation is referred to as an “extended operation”.

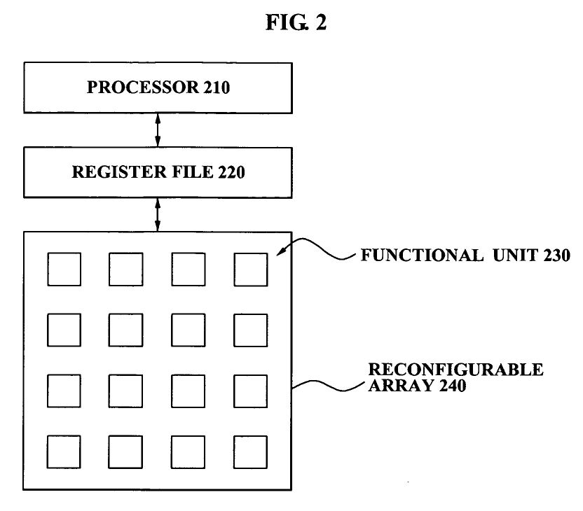

FIG. 2 is a configuration diagram illustrating a configuration of an operation process system according to an exemplary embodiment of the present invention.

The operation process system according to the exemplary embodiment of the present invention includes a processor 210, a register file 220 and a plurality of functional units 230. A reconfigurable array 240 is comprised of the plurality of functional units 230. Hereinafter, a specific description is given for each element.

The processor 210 is a device processing the operation of the program and is located in a device such as a computer, a personal digital assistant (PDA), a portable multimedia player (PMP), a cellular phone, and the like, and executed in each device. The program is made of a set of a plurality of operations to be processed in the processor 210. The operation generally includes the operations, for example, addition, subtraction, multiplication, shift, logical sum, logical multiplication, and the like, processed via an arithmetic logic unit (ALU) and the operation provided for a memory access, for example, a load, a store and the like. Accordingly, the processor 210 may include an ALU device processing the arithmetic operation and a device enabling a memory to be accessed. A type of the operation processed varies according to the type of the processor 210. Also, the present invention is not limited to the type of the processor 210 and any type of processor may be applied.

The register file 220 is generally memory that is a set of registers used to access data for the processor 210. Since access times of when a general main memory storing the data in the device, such as the computer and the like, accesses the data is relatively great, a cycle may be greatly increased when the processor 210 directly accesses the main memory. Accordingly, the register is designed to be located close to the processor 210, to store the data of the main memory in the register according to a memory access instruction in the processor 210, and to enable the processor 210 to access the register and to identify the data as required.

In the present invention, when each of the plurality of functional units 230 processes the extended operation by controlling the processor 210, each of the plurality of functional units 230 enables the processor 210 to process the necessary operation within the shortest period of time by recording an input value required for the operation in the register file 220 which is a memory the processor 210 may access most quickly.

Also, the register file 220 in the present invention may enable the data between each of the plurality of functional units 230 and the processor 210 to be exchanged by using any one register of the register file 220 and may be configured so that each of the plurality of functional units 230 and the processor 210 separately and respectively access an individual register of the register file 220, and the data between the register file 220 and the processor 210 and functional units 230 is received and transmitted. The present invention is not limited to a configuration of the register file 220.

Each of the plurality of functional units 230 indicates the hardware configured to process the operation and the operation processed classified by each of the plurality of functional units 230 is defined. Accordingly, there is the diverse plurality of functional units 230 according to the type of the operation processed. Each of the plurality of functional units 230 generally processes the operation by receiving a plurality of input values and returns a result value of the operation.

Also, each of the plurality of functional units 230 may include a function of controlling the processor to process the extended operation. For example, each of the plurality of functional units 230 may enable the processor to process the extended operation corresponding to the exception generated in each of the plurality of functional units 230 by generating an exception identified in the processor.

The reconfigurable array 240 is made of the plurality of functional units 230 and enables a plurality of operations to be simultaneously processed by operating the plurality of functional units 230. Similarly, since the plurality of operations may be simultaneously processed, software pipelining may be embodied by using the reconfigurable array 240. The reconfigurable array 240 may include each of the plurality of functional units 230 processing the diverse operations and may include a connection line exchanging the data and a temporary memory device storing the exchanged data. Also, the reconfigurable array 240 may include the connection line with the register file 220 to transmit the data to the processor 210 and store the data in the register file 220.

Each of the plurality of functional units 230 included in the reconfigurable array 240 may implement each operation and enable another operation to be implemented according to an operation result by transmitting the operation result to another plurality of functional units. Thus, according to an operation order, it is required to appropriately locate each of the plurality of functional units 230 to efficiently transmit the data.

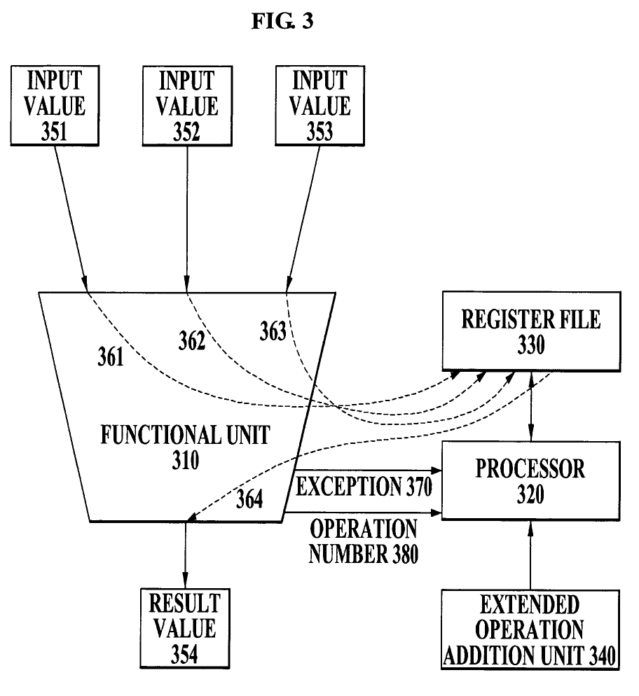

FIG. 3 is a configuration diagram illustrating a system configuration for processing an extended operation in an operation process system according to an exemplary embodiment of the present invention.

As illustrated in FIG. 3, the operation process system according to the exemplary embodiment of the present invention includes one of a plurality of functional units 310, a processor 320, a register file 330, and an extended operation addition unit 340. Hereinafter, a specific description is given classified by each element.

Each of the plurality of functional units 310 processes the primitive operation, and controls the processor 320 to process the extended operation. Each of the plurality of functional units 310 is a hardware device processing the operation that is a basic unit configuring a program, and returns a result value 354 after implementing the operation by receiving a plurality of input values 351, 352 and 353 required for the operation. A type of the operation processed is set from when the hardware in each of the plurality of functional units 310 is designed. For example, a certain plurality of functional units in the plurality of functional units 310 may be configured to process an operation such as addition and subtraction, and another plurality of functional units in the plurality of functional units 310 may be configured to process an operation such as addition, subtraction, multiplication, and division. Also, the other plurality of functional units in the plurality of functional units 310 may be configured to process an operation such as floating point operation.

Similarly, the operation processed by using the hardware designed in each of the plurality of functional units 310 is referred to as a “primitive operation”, and each of the plurality of functional units 310 processes the primitive operation and returns a result of the primitive operation. The plurality of input values 351, 352, and 353 may be input in each of the plurality of functional units 310 to process the primitive operation, and a number of input values required according to the type of the operation varies.

Similarly, if the operation required to be processed in each of the plurality of functional units 310 is the primitive operation, the operation may be processed by using the hardware of each of the plurality of functional units 310. However, since the extended operation is an operation that may not be processed by using the hardware of each of the plurality of functional units 310 if the operation required to be processed is the extended operation, the operation may be processed by the processor 320. The extended operation is the operation including a control flow that makes it difficult to embody the software pipelining and may have a program form where the plurality of primitive operations is combined. Similarly, there is an effect to simply embody the software pipelining by processing the extended operation configured by combining the plurality of primitive operations including the control flow at one time by controlling the processor 320 in each of the plurality of functional units 310.

If the operation required to be processed in each of the plurality of functional units 310 is the extended operation, each of the plurality of functional units 310 copies the input values 351, 352 and 353 of the extended operation in the register file 330 and enables the processor 320 to recognize the input values. Accordingly, the processor may access the input values required for the operation in a memory that is the simplest to access. After copying the input values, each of the plurality of functional units 310 generates an exception 370 in the processor 320. The exception 370 indicates a signal generated to stop a current job and immediately process when a problem is generated in the device such as the computer, or a situation required to be processed is generated due to receiving an input from an input device. Accordingly, when the exception is generated, the processor 320 stops the current job and implements the operation corresponding to the exception 370. Similarly, a module to enable the operation corresponding to the exception 370 to be implemented is referred to as an “exception handler”. The exception handler identifies the type of the exception 370 and requires the operation corresponding to the type of the exception 370 to be processed. Since the processor generally includes a similar basic exception handler, the processor 320 may be controlled by each of the plurality of functional units 310 by merely adding the operation to require the exception handler to process the exception 370 from each of the plurality of functional units 310.

Since the extended operation is configured in the form of the program, when each of the plurality of functional units 310 generates the exception 370, the exception handler of the processor 320 may identify the exception 370 and enable the program for processing the extended operation to be executed. In this instance, if there are various extended operations, the extended operation may require the exception handler to determine the program to execute for processing the certain extended operation by transmitting an operation number 380 of the extended operation along with the exception 370 to the processor 320.

The processor 320 is a device executing the program for processing the extended operation and, similar to the description above, executes the program corresponding to the type of the extended operation according to the operation of the exception handler. Similarly, to process the extended operation, the processor 320 may store program code of the program in a recording device to separately process the plurality of extended operations and thereby process the extended operation. In this instance, to identify the type of the extended operation, the processor 320 may store the program code corresponding to the operation number 380 and identify the program code corresponding to the operation number 380, which is received with the exception 370 from each of the plurality of functional units 310, from the recording device.

Also, the processor 320 may receive the input values, which are required to process the extended operation, from the register file 330. Since each of the plurality of functional units 310 copies the input values to the register file 330, there is an effect in that the processor 320 may receive the input values from the register file that is the memory that may be most simply accessed. Also, the processor 320 may process the extended operation, record the process result in the register file 330 and require each of the plurality of functional units to provide the process result. Each of the plurality of functional units 310 may receive the process result with reference to the register file 330 and return the process result as a result value 354.

Similar to the description above, if the extended operation is processed, since a side using each of the plurality of functional units 310 may input the input values 351, 352 and 353 in each of the plurality of functional units 310 regardless of an internal operation of each of the plurality of functional units 310, and receive the result value 354 according to the operation, the extended operation made of the plurality of primitive operations including the control flow may be similarly processed as one primitive operation. Accordingly, since the operation may be similarly processed as a case of excluding the control flow, the software pipelining is simply embodied.

For example, when there is a loop configured similar to a following description, the software pipelining may not be embodied due to the control flow in the fourth and fifth lines in a conventional art.

1: while(TRUE){
2: a = 10;
3: b = a + c;
4: if(a > b) d = a;
5: else d = b;
6: }

Accordingly, it is possible to modify the program into a program excluding the control flow similar to the following description by defining the extended operation referred to as “max” processing the fourth and fifth lines of the above program.

1: while(TRUE){
2: a = 10;
3: b = a + c;
4: d = max(a, b);
5: }

Max actually includes control flow in the above program, but each of the plurality of functional units 310 processes the operation by controlling the processor 320, and accordingly, the operation is processed as one operation such as an addition operation. Thus, the loop of the program may become the program made of three operations excluding the control flow and embody software pipelining.

Since the register file 330 is a memory used for transmitting the data from each of the plurality of functional units 310 to the processor 320 and may be directly and quickly accessed by the processor 320, the extended operation may be quickly processed. The register file 330 may be made of a plurality of the register files, be configured so that each of the plurality of functional units 310 and the processor 320 may separately and respectively access an individual register of the register file 330, use the data, and exchange the data with the register file 330, and may be configured to jointly have one register file.

The extended operation addition unit 340 receives a request for an additional extended operation, and configures the processor 320 to process the extended operation corresponding to the request. The request may include the program code of the program executed to process the extended operation. Since the extended operation has the program in a form made of the plurality of primitive operations, the extended operation may be processed in the processor 320 when the program for processing the extended operation is stored in a memory device. Accordingly, when the extended operation is added according to a user's request for an additional extended operation, it is required to receive and store the program code corresponding to the extended operation.

Also, the extended operation addition unit 340 assigns the extended operation corresponding to the request with an operation number, modifies the received program code to correspond to the operation number, and thereby stores the program code in the recording device. Accordingly, by merely transmitting the operation number from each of the plurality of functional units 310 to the processor 320, the processor may process the extended operation by identifying the extended operation required to process, and identify the program code corresponding to the operation number from the memory device, to be operated.

Similarly, there is the effect that the user may extend the operation according to the user's need while eliminating a need for adding the hardware device by enabling the user to merely add the extended operation via the extended operation addition unit 340.

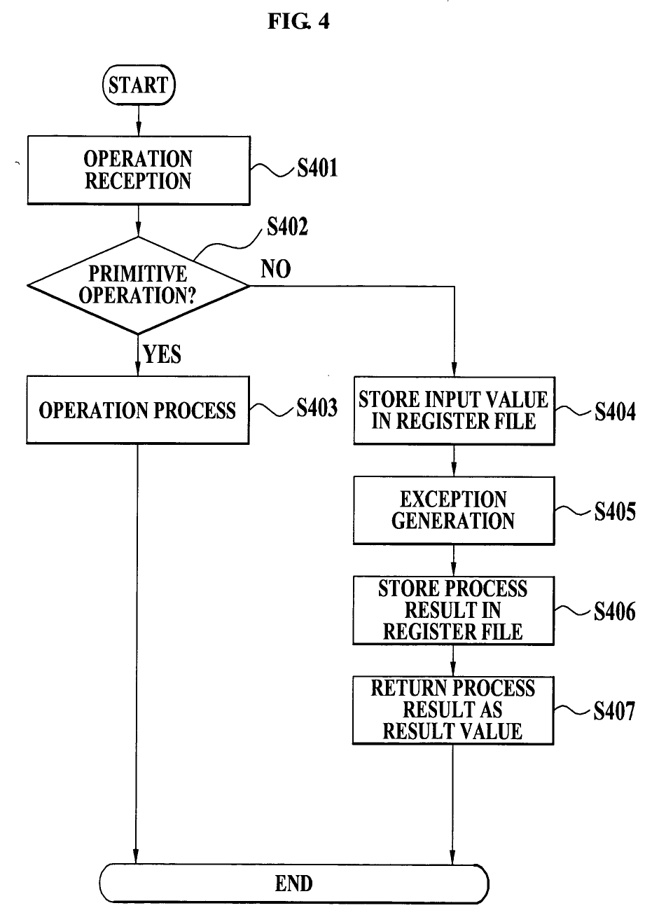

FIG. 4 is a flowchart illustrating a flow of an operation process method according to an exemplary embodiment of the present invention.

In operation S401, the operation required to be processed in each of the plurality of functional units is received. Each of the plurality of functional units generally processes the operation by reading the program stored in the memory. The operation may include both the primitive operation and the extended operation.

In operation S402, whether the operation received in operation S401 is the primitive operation is identified. To discriminate between the primitive operation and the extended operation, a bit to identify whether the operation is the primitive operation or the extended operation may be added to an operation code, and a discrimination between the primitive operation and the extended operation may also be made by other diverse methods. Any method of discriminating between the primitive operation and the extended operation may be applied to the present invention and the present invention is not limited to the above discrimination method.

In operation S403, if the operation received in operation S401 is determined as the primitive operation in S402, the operation is processed. Since each of the plurality of functional units originally includes the hardware for processing the primitive operation, the primitive operation may be processed using the hardware.

In operation S404, if the operation received in operation S401 is determined as the extended operation, the input values of the operation are stored in the register file. Since the register file is a memory device that the processor may directly access, the input values may be simply identified in the processor by enabling each of the plurality of functional units to store the input values in the register file.

In operation S405, the extended operation may be processed by generating the exception in the processor. When the exception is generated, the exception handler of the processor is operated and processes the exception. Thus, there is the effect that the processor may be controlled eliminating a need for separate communication by configuring the exception handler to process the extended operation corresponding to the exception.

In operation S406, the processor processes the extended operation and stores the process result in the register file. Each of the plurality of functional units controlling the processor to process the extended operation identifies and returns the process result of the extended operation. Accordingly, since the side using each of the plurality of functional units may not identify whether each of the plurality of functional units directly processes the operation or processes the operation by controlling the processor, the extended operation may be processed similar to the primitive operation.

In operation S407, each of the plurality of functional units receives the process result stored in the register file and returns the process result as a result value. Similarly, each of the plurality of functional units may transmit the input values and receive the result value by eliminating a need for configuring the processor and a separate communication channel and by using the register file.

The operation process method according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the exemplary embodiments of the present invention, it is possible to simply use a software pipelining technology.

Also, according to the exemplary embodiments of the present invention, it is possible to process an extended operation in software by enabling a separate processor to process the extended operation.

Also, according to the exemplary embodiments of the present invention, it is possible to add an extended operation desired by a user by processing the extended operation in software.

Also, according to the exemplary embodiments of the present invention, it is possible to efficiently use a processor by generating an exception, enabling the processor to process an extended operation, and using an exception handler in the processor.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An operation process system of processing an operation of a computer program, the system comprising:
a plurality of functional units, each of the plurality of functional units being operable to process a primitive operation; and
a processor which is operable to process an extended operation according to a control of at least one of the plurality of functional units.

2. The system of claim 1, wherein the at least one of the plurality of functional units directly processes the primitive operation if the operation is the primitive operation, and controls the processor to process the extended operation if the operation is the extended operation.

3. The system of claim 1, wherein the at least one of the plurality of functional units stores an input value of the operation in a register file, and processes the operation by generating an exception in the processor if the operation is the extended operation.

4. The system of claim 3, wherein the at least one of the plurality of functional units transmits an operation number which designates a type of the operation, to the processor.

5. The system of claim 4, further comprising:
a recording device which modifies the operation number to correspond to a program code which is used for processing the operation, and then stores the operation number,
wherein the processor implements the program code corresponding to the operation number with reference to the recording device, and processes the operation.

6. The system of claim 3, wherein the processor stores a process result of the operation in the register file, and the at least one of the plurality of functional units receives the process result from the register file.

7. The system of claim 6, wherein the at least one of the plurality of functional units returns the received process result as a result value of the operation.

8. The system of claim 1, wherein a reconfigurable array comprises the plurality of functional units.

9. The system of claim 1, wherein the plurality of functional units processes a plurality of primitive operations and simultaneously controls the processing of the extended operation.

10. The system of claim 1, further comprising:
an extended operation addition unit which receives a request for an additional extended operation, and configures the processor to process the additional extended operation corresponding to the request.

11. The system of claim 10, wherein the request comprises a program code which processes the additional extended operation in the processor.

12. The system of claim 11, wherein the extended operation addition unit assigns the addition extended operation corresponding to the request, with an operation number, and modifies the program code to correspond to the operation number, and thereby stores the program code in a recording device.

13. An operation process method of processing an operation of a computer program, the method comprising:
receiving the operation from at least one of a plurality of functional units;
processing the operation with the one of the plurality of functional units if the operation is a primitive operation; and
processing an extended operation by controlling a process if the operation is an extended operation.

14. The method of claim 13, wherein the processing the extended operation comprises:
storing, using the at least one of the plurality of functional units, an input value of the operation in a register file; and
processing, using the at least one of the plurality of functional units, the operation by generating an exception.

15. The method of claim 14, wherein the processing the extended operation further comprises:
storing, using the processor, a process result of the operation in the register file; and
receiving, using the at least one of the plurality of functional units, the process result from the register file.

16. The method of claim 15, wherein the processing the extended operation further comprises:
returning, using the at least one of the plurality of functional units, the received process result as a result value.

17. A computer-readable recording medium storing a program for implementing the method according to claim 13.
